(19) United States
(12) Patent Application Publication
(10) Pub. No.: US 2004/0105470 A1
(43) Pub. Date: Jun. 3, 2004

(54) Method for reducing non-linearities in a laser communication system

(76) Inventor: Aaron Bond, Orefield, PA (US)

Correspondence Address: RATNERPRESTIA, P O BOX 980, VALLEY FORGE, PA, 19482-0980, US

(21) Appl. No.: 10/713,482

(22) Filed: Nov. 14, 2003

Related U.S. Application Data
(60) Provisional application No. 60/319,697, filed on Nov. 15, 2002.

(51) Int. Cl. H01S 3/10

(52) U.S. Cl. 372/26

(57) ABSTRACT

A system including a laser and a semiconductor optical amplifier (SOA) and a method of generating a dithered laser light with substantially constant amplitude with this system. The laser drive current is modulated to generate a modulated laser light with optical linewidth dithering. The modulated laser light is coupled into the SOA. The SOA drive current is modulated approximately 180° out of phase with the laser drive current to generate the dithered laser light with substantially constant amplitude.

This application is related to and claims the benefit of U.S. Provisional Application No. 60/319,697 entitled METHOD FOR REDUCING NON-LINEARITIES IN A LASER COMMUNICATION SYSTEM filed on Nov. 15, 2002.

### FIELD OF THE INVENTION

The present invention relates to the field of systems and methods for providing a dithered laser source, specifically an amplified, dithered laser source having a more constant intensity output signal.

### BACKGROUND OF THE INVENTION

In applications involving high launch powers into optical fiber, non-linear optical effects, such as stimulated Brillouin scattering or stimulated Raman scattering, may result in a loss of power at the incident frequency and may become an important loss mechanism for optical fibers. Such non-linear optical effects may greatly limit the benefits of using high launch powers to extend the range of long-haul fiber optics transmission lines.

A common practice to reduce the deleterious effects of such non-linear phenomena is to “dither” the optical frequency of the laser source to spread the laser optical linewidth and thereby reduce the non-linearities. This dithering may be accomplished by adding a modulation component to the drive current of the laser source. The relationship between drive current and optical frequency for a specific semiconductor laser is readily determinable. Thus, a modulation of the drive current may provide a well-defined modulation of the optical frequency of the laser source with minimal lag. The frequency of this dithering modulation is desirably several orders of magnitude less than bit rate of the optical communications system in which the laser source is included. For example, in a 1, 2.5 or 10 Gbit/s communications system or in an analog communications system, a 10 kHz dithering modulation may be desirable. A large difference between the modulation frequency and the dither frequency may reduce any interference from the dithering with the transmission of the signal data.

The dithering modulation of a laser source not only modulates the optical frequency, but may also modulate the amplitude of the laser source. This may be undesirable, particularly if the desired dithering of the optical frequency requires a significant modulation of the drive current, or if the laser source is operated near its lasing threshold. Therefore, it is desirable to reduce the amount of amplitude modulation in the output signal of the laser source.

### SUMMARY OF THE INVENTION

An exemplary embodiment of the present invention is a method of generating dithered laser light with substantially constant amplitude in a system including a laser and a semiconductor optical amplifier (SOA). The drive current of the laser is modulated to generate modulated laser light with optical linewidth dithering. The modulated laser light is coupled into the SOA. The drive current of the SOA is modulated approximately 180° out of phase with the laser drive current to generate dithered laser light with substantially constant amplitude.

Another exemplary embodiment of the present invention is an optical source to provide substantially constant amplitude, dithered laser light. The exemplary optical source includes a laser source, an SOA optically coupled to the laser source, a current modulator electrically coupled to the laser source to provide a first modulated drive current to the laser source, and a phase shifter electrically coupled to the current modulator and to the SOA. The phase shifter shifts the phase of the first modulated drive current to create a second modulated drive current, and provides this second modulated drive current to the SOA.

An additional exemplary embodiment of the present invention is a method of generating a dithered laser light with substantially constant amplitude in a system including a laser and a variable optical attenuator (VOA). The laser drive current is modulated to generate a modulated laser light with optical linewidth dithering. The modulated laser light is coupled into the VOA. The VOA drive current in modulated approximately in phase with the laser drive current to generate dithered laser light with substantially constant amplitude.

A further exemplary embodiment of the present invention is an optical source to provide substantially constant amplitude, dithered laser light. The exemplary optical source includes a laser source, a VOA optically coupled to the laser source, and a current modulator electrically coupled to the laser source and the VOA. The current modulator provides a drive current modulation to the laser source and the VOA.

Yet another exemplary embodiment of the present invention is an optical transmitter which uses substantially constant amplitude, dithered laser light. The exemplary optical transmitter includes a laser source, an electroabsorption modulator (EAM) optically coupled to the laser source, a current modulator electrically coupled to the laser source and the EAM, and a signal generator electrically coupled to the EAM. The current modulator provides a drive current modulation having a first frequency to the laser source and the EAM. The signal generator provides a signal modulation to the EAM to modulate an optical signal of the optical transmitter at a second frequency. The second frequency is significantly greater than the first frequency.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a block diagram of an exemplary optical source to provide substantially constant amplitude, dithered laser light according to the present invention.

FIG. 2 is a flow chart illustrating an exemplary method of operating the optical source of FIG. 1 according to the present invention.

FIG. 3A is a block diagram of another exemplary optical source to provide substantially constant amplitude, dithered laser light according to the present invention.

FIG. 3B is a block diagram of an exemplary optical transmitter to provide substantially constant amplitude, dithered laser light signal according to the present invention.

FIG. 4 is a flow chart illustrating an exemplary method of operating the optical source of FIG. 3A according to the present invention.

### DETAILED DESCRIPTION OF THE INVENTION

In many optical systems an optical amplifier, such as a semiconductor optical amplifier (SOA), may be placed in the optical path of light from the laser source. This arrangement may be particularly useful in systems where a high power optical signal is desired. The SOA provides optical gain, which can compensate for various component and coupling losses. An SOA is designed similarly to a semiconductor laser, but without feedback, and thus may operate as a single pass optical amplifier.

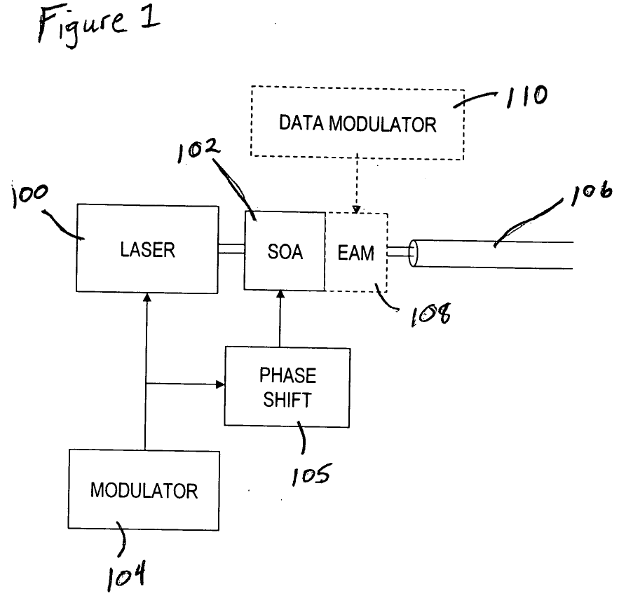

FIG. 1 illustrates an exemplary embodiment of such a system. Light from laser 100 is coupled into SOA 102. The light is amplified by SOA 102 and then coupled into optical fiber 106. In a laser/SOA device, as shown in FIG. 1, for example, SOA 102 desirably has a gain profile similar to laser source 100, the output signal of which is to be amplified by SOA 102. An SOA may be formed monolithically with a semiconductor laser, of the same material, and driven by the same current source as the laser. Alternatively, the SOA and laser may be formed as separate components, as shown in FIG. 1. The resultant optical signal of a laser/SOA device may have significantly higher optical power than the optical signal of the laser individually. It is noted that the light from this exemplary optical source may, alternatively, be coupled into other passive or active optical components, such as multiplexers, splitters, detectors, additional SOA's, variable optical attenuators, or a combination thereof.

Current modulator 104 provides a modulated drive current to dither the optical frequency of laser 100 and thereby broaden the optical linewidth of the amplified laser light coupled into optical fiber 106. Current modulator 104 may desirably be a current source which includes a relatively small amplitude periodic current modulation about a relatively large constant current level (i.e. modulation amplitude to constant level of 1:2 or greater). Alternatively, the constant current level and the periodic current modulation may be provided by separate subcomponents and combined via a bias tee or other common means for combining current sources.

Current modulator 104 may also desirably be electrically coupled to SOA 102, through phase shifter 105. Phase shifter 105 may shift the phase the periodic current modulation of the drive current by delaying the modulated drive current to SOA 102 by approximately half a cycle compared to the modulated drive current of laser 100. Alternatively, phase shifter 105 may separate the constant current from the periodic current modulation, invert the periodic current modulation, and recombine the constant current and the periodic current modulation. Of course, if current modulator 104 includes separate subcomponents to provide the constant current level and the periodic current modulation, the current sources from these separate subcomponents may not be combined until after the phase of the periodic current modulation has been shifted.

Because the optical gain of an SOA is approximately proportional to the drive current, this drive current modulation induces a modulation in the gain of SOA 102. By adjusting the phase shift in the drive current modulation of SOA 102, it may be possible to set the gain modulation 1800 out of phase with the amplitude modulation of the laser light coupled into SOA 102 from laser 100. Therefore, the amplitude modulation created from the dithering of the laser source may be substantially cancelled out by applying the out of phase modulation on the SOA drive current from phase shifter 105. In this way, the optical linewidth of laser 100 may be desirably broadened, while minimizing distortions in optical amplitude.

It is noted that the exact phase shift desired may vary from 180° due to possible differences in the response time lags of laser 100 and SOA 102, as well as phase sifts due to transit time for the light traveling between the laser and the SOA. Therefore, it may be desirable for the time delay (or phase shift) applied by a delay-type phase shifter to be variable. The desired phase shift added to the SOA drive current may be tuned by monitoring the amplified laser light emitted by SOA 102 and adjusting the phase shift added by phase shifter 105 to minimize the amplitude modulation of the monitored light. It may also be desirable for phase shifter 105 to include circuitry to allow adjustment of the amplitude of the periodic current modulation and/or the constant current level of the drive current applied to SOA 102, independent of these parameters for the drive current applied to laser source 100.

Optional electroabsorption modulator (EAM) 108 (shown in phantom) may be included between SOA 102 and optical fiber 106 to modulate the amplified laser light to produce an optical signal. This EAM may be a separate optical component or may be monolithically integrated with SOA 102, as in the T-Networks EAMP™. The drive current of EAM 108 may be modulated by data modulator 110 (also shown in phantom) to encode an optical signal on the dithered laser light.

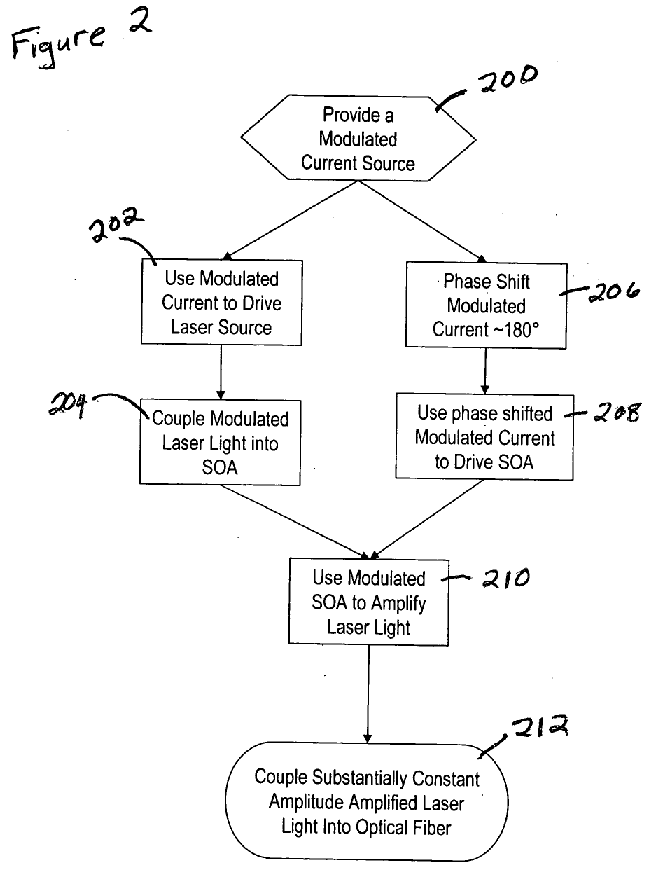

Another exemplary embodiment of the present invention is a method of using an exemplary optical source to reduce the amplitude modulation of the laser source associated with using the drive current to dither the optical frequency. In this exemplary method the amplitude modulation of the laser source is compensated by modulating the gain of an SOA. FIG. 2 is a flow chart illustrating this exemplary method. A modulated current is provided, step 200. This modulated current includes a relatively small periodic current modulation about a relatively large constant current level.

The modulated current is used to drive the laser source, step 202, producing a dithered laser light. This dithered laser light has a modulated intensity, as well as a broadened optical linewidth. The dithered laser light is coupled into the SOA, step 204.

The original modulated current provided in step 200 is phase shifted by approximately 180°, step 206. This phase shifted, modulated current is then used to drive the SOA, step 208. The modulated SOA amplifies the dithered laser light to desirably produce a substantially constant amplitude, amplified laser light, step 210. This substantially constant amplitude, amplified laser light is coupled into an optical fiber, or other optical component, step 212. Additionally, in step 212 the output dithered light from the SOA may be monitored. The desired phase shift in step 206 may be determined, through this monitoring of the output light and adjustment of the applied phase shift. This may be achieved using, for example, a closed loop controller As described above with reference to FIG. 1, it may be desirable to adjust the amplitude of the periodic current modulation and/or the constant current level of this phase shifted modulated current generated in step 206 to improve the quality of the final output signal, as well. Non-linear optical effects resulting in loss of light intensity in the optical fiber are desirably reduced by broadening the optical linewidth through dithering in step 204.

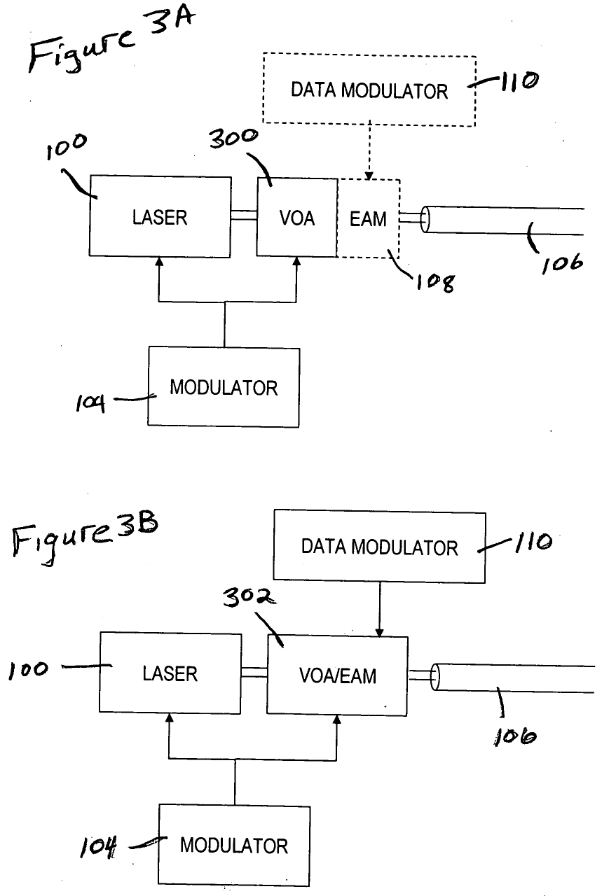

FIGS. 3A and 3B illustrate two more exemplary embodiments of the present invention. These embodiments use optical absorption, rather than optical gain, components to compensate for amplitude intensities caused by dithering of laser source 100. In FIG. 3A, the SOA of FIG. 1 is replaced by variable optical attenuator (VOA) 300. The absorptivity of a VOA is approximately proportional to the drive current. Therefore, a drive current modulation may induce a modulation in the attenuation of VOA 300, similar to the induced gain modulation of the SOA in the exemplary embodiment of FIG. 1. The modulated attenuation of VOA 300 may desirably be used to compensate for the modulated intensity of laser 100, but without shifting the phase of the modulated current, i.e. the modulated current of modulator 104 may be directly coupled into VOA 300, as shown. It may be desirable to adjust the amplitude of the periodic current modulation provided to VOA 300 to improve the intensity modulation compensation. Also, it may be desirable to adjust the constant current level provided to VOA 300 to limit the overall attenuation of the optical source.

As in the exemplary embodiment of FIG. 1, EAM 108 and data modulator 110 may be included in this exemplary embodiment to create a substantially constant amplitude, dithered optical transmitter. EAM 108 may be a separate optical component or may be formed monolithically with VOA 300. It is noted that an EAM and a VOA may be formed in the same manner of the same materials. The main difference between the two components is one of degree. An EAM is desirably operated such that is switches between states of low loss transmission and high loss absorption (logical 1 and 0), while a VOA may be varied continuously between these extremes. Therefore, the exemplary embodiment of FIG. 3B employs VOA/EAM 302 to perform both of these tasks. In this exemplary optical transmitter configuration, VOA/EAM 302 is electrically coupled both to modulator 104 (for a relatively low frequency, low amplitude, periodic dithering current) and data modulator 110 (for a relatively high frequency, high amplitude aperiodic data signal current).

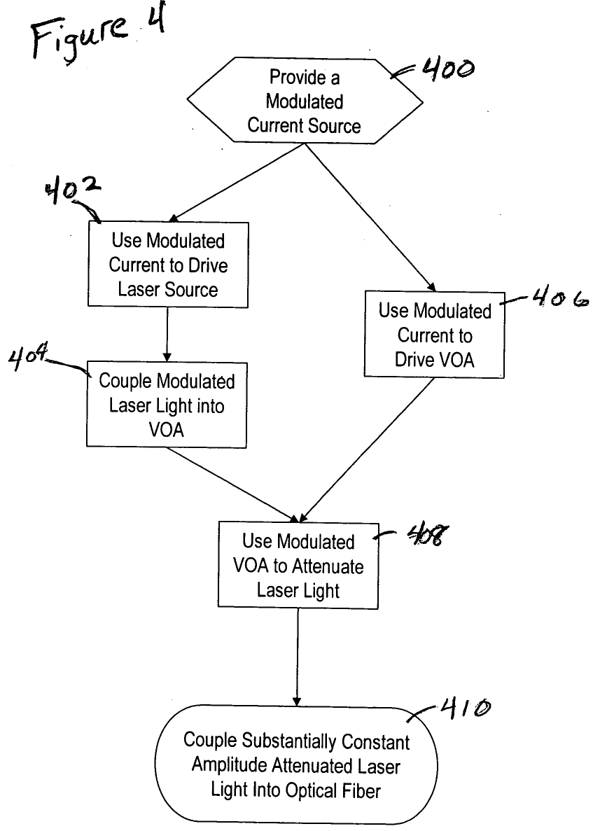

FIG. 4 is a flow chart illustrating an exemplary method of compensating for amplitude modulations of a dithered laser source. In this exemplary method the amplitude modulation of the laser source is compensated by modulating the absorption of a VOA. A modulated current is provided, step 400. This modulated current may desirably include a relatively small periodic current modulation about a relatively large constant current level.

The modulated current is used to drive the laser source, step 402, producing a dithered laser light. This dithered laser light has a modulated intensity, as well as a broadened optical linewidth. The dithered laser light is coupled into the VOA, step 404.

The modulated current provided in step 200 is then used to drive the VOA, step 406. The modulated VOA desirably attenuates the dithered laser light to produce a substantially constant amplitude, dithered laser light, step 408. This substantially constant amplitude, dithered laser light is coupled into an optical fiber, or other optical component, step 410. Additionally, in step 410 the output dithered light from the SOA may be monitored. As described above with reference to FIG. 3A, it may be desirable to adjust the amplitude of the periodic current modulation and/or the constant current level of this phase shifted modulated current generated in step 406 to improve the quality of the final output signal. A small phase shift in step 406 may also be desirably added, based this monitoring of the output light, as well.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of generating a dithered laser light with substantially constant amplitude in a system including a laser and a semiconductor optical amplifier (SOA), comprising the steps of:
a) amplitude modulating a laser drive current of the laser to generate a modulated laser light with optical linewidth dithering;
b) coupling the modulated laser light into the SOA; and
C) modulating an SOA drive current of the SOA approximately 180° out of phase with the laser drive current to generate the dithered laser light with substantially constant amplitude.

2. The method according to claim 1 wherein step (c) includes the steps of:
c1) setting a phase of a modulation of the SOA drive current 1800 out of phase with the laser drive current;
c2) detecting an amplitude of the dithered laser light; and
c3) adjusting in phase at least one of the modulation of the laser drive current and the modulation of the SOA drive current until an amplitude of the dithered laser light is substantially constant.

3. An optical source to provide substantially constant amplitude, dithered laser light, comprising;
a laser source;
a semiconductor optical amplifier (SOA) optically coupled to the laser source;
a current modulator electrically coupled to the laser source to provide a first modulated drive current to the laser source; and
a phase shifter electrically coupled to the current modulator and to the SOA, the phase shifter shifting a first modulated drive current phase of the first modulated drive current to create a second modulated drive current, and the phase shifter providing the second modulated drive current to the SOA.

4. The optical source according to claim 3, wherein the phase shifter inverts the first modulated drive current in phase to generate the second modulated drive current.

5. The optical source according to claim 3, wherein the phase shifter shifts the first modulated drive current phase of the first modulated drive current approximately 180° to create the second modulated drive current.

6. The optical source according to claim 3, wherein the laser source and the SOA are monolithically integrated.

7. The optical source according to claim 3, wherein the phase shifter amplifies the second modulated drive current before providing the second modulated drive current to the SOA.

8. The optical source according to claim 3, wherein the phase shifter attenuates the second modulated drive current before providing the second modulated drive current to the SOA.

9. The optical source according to claim 3, further comprising an electroabsorption modulator (EAM) optically coupled to the SOA.

10. The optical source according to claim 9, wherein the EAM and the SOA are monolithically integrated.

11. A method of generating a dithered laser light with substantially constant amplitude in a system including a laser and a variable optical attenuator (VOA), comprising the steps of:
a) modulating a laser drive current of the laser to generate a modulated laser light with optical linewidth dithering;
b) coupling the modulated laser light into the VOA; and
C) modulating a VOA drive current of the VOA approximately in phase with the laser drive current to generate the dithered laser light with substantially constant amplitude.

12. The method according to claim 11 wherein step (c) includes the steps of:
c1) setting a phase of a modulation of the VOA drive current in phase with the laser drive current;
c2) detecting an amplitude of the dithered laser light; and
c3) adjusting at least one of the phase and an amplitude of the modulation of the VOA drive current until an amplitude of the dithered laser light is substantially constant.

13. An optical source to provide substantially constant amplitude, dithered laser light, comprising;
a laser source;
a variable optical attenuator (VOA) optically coupled to the laser source; and
a current modulator electrically coupled to the laser source and the VOA to provide a drive current modulation to the laser source and the VOA.

14. The optical source according to claim 13, wherein the current modulator amplifies the drive current modulation before providing the drive current modulation to the laser source.

15. The optical source according to claim 13, wherein the current modulator amplifies the drive current modulation before providing the drive current modulation to the VOA.

16. An optical transmitter which uses substantially constant amplitude, dithered laser light, comprising;
a laser source;
an electroabsorption modulator (EAM) optically coupled to the laser source;
a current modulator electrically coupled to the laser source and the EAM to provide a drive current modulation having a first frequency to the laser source and the EAM; and
a signal generator electrically coupled to the EAM to provide a signal modulation for modulating an optical signal of the optical transmitter at a second frequency significantly greater than the first frequency.
